(19) United States
(12) Patent Application Publication
(10) Pub. No.: US 2008/0079763 A1
(43) Pub. Date: Apr. 3, 2008

(54) Systems And Methods For Verifying The Operational Conditions Of Print Heads in a Digital Printing Environment

(75) Inventor: Timothy J. Abrott, Normandy Park, WA (US)

Correspondence Address: WEYERHAEUSER COMPANY;INTELLECTUAL PROPERTY DEPT., CH 1J27, P.O. BOX 9777, FEDERAL WAY, WA, 98063, US

(73) Assignee: Weyerhaeuser Co., Federal Way, WA (US)

(21) Appl. No.: 11/536,856

(22) Filed: Sep. 29, 2006

(51) Int. Cl. B41J 29/393

(52) U.S. Cl. 347/19

(57) ABSTRACT

A print verification system includes a print station for printing an image and a test pattern onto a selected substrate, an image capture device for capturing a digital image of the test pattern, and a computing system for controlling the printing process. The computing system includes an image analysis module for analyzing the images captured by the image capture device. Upon analysis of the captured image, the system is capable of generating an alert signal if a determination is made that the pattern is representative of an adverse operational condition.

### BACKGROUND

Inkjet printing has gained popularity in a number of industries. One such industry is the shipping industry, which is currently utilizing inkjet printing systems for printing images onto cellulous based substrates, such as shipping containers, boxes, and point of sale displays. The inkjet printing process involves manipulation of drops of ink ejected from an orifice, or a number of orifices, of a print head onto an adjacent print medium or substrate. An inkjet print head consists of an array or a matrix of ink channels or cavities each ending by an orifice or nozzle. Each nozzle selectively ejects ink droplets in the direction of the printing substrate. A given nozzle of the print head ejects the ink droplet in a predefined print position on the media. An assembly of the adjacently positioned on the media ink droplets creates a predetermined print pattern or image. Relative movement between the media or substrate and the print head enables printing substrate coverage and image creation.

The quality of the printed image produced by an inkjet printer to a large extent depends on whether the print head is working properly. One problem that commonly occurs in inkjet print heads is clogged nozzle orifices. This can occur, for example, by the presence of debris, a few examples of which include ink formed during the droplet ejection process, dust, paper and fabric lint, etc.

A technician operating the conventional printing system would heretofore manually check each print image for quality, and if a problem in the print quality existed due to poorly working print heads, the operator would manually instigate a print head cleaning cycle. This process would repeat itself through the entire print job.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with aspects of the present invention, a method is provided for verifying the print quality of a printed image. The method includes the steps of advancing a substrate through a printing nip; printing one or more layers of ink via an inkjet print head onto the substrate to form a print image; printing a test pattern on the substrate comprised of one or more ink colors via the print head as the substrate is advanced through the printing nip; capturing a digital image of the test pattern; and analyzing the digital image of the test pattern to determine the operational condition of the print head.

In accordance with another aspect of the present invention, a method is provided for verifying the print quality of a printed image. The method includes the steps of advancing a substrate through a printing nip; printing one or more layers of ink via an inkjet print head onto the substrate to form a print image; printing a test pattern on the substrate comprised of one or more ink colors via the print head as the substrate is advanced through the printing nip; capturing a digital image of the test pattern; comparing the digital image of the test pattern to a corresponding reference test pattern for determining the operational condition of the print head; and generating an alert signal based on results of the analysis of the printed test pattern indicating an adverse operational condition of the print head.

### DESCRIPTION OF THE DRAWINGS

The foregoing aspects and many of the attendant advantages of this invention will become more readily appreciated as the same by reference to the following detailed description, when taken in conjunction with the accompanying drawings, wherein:

FIG. 1 is a perspective view of an exemplary embodiment of a print verification system constructed in accordance with aspects of the present invention;

FIG. 2 is a block diagram of one exemplary embodiment of a computing system suitable for use in the print verification system of FIG. 1;

FIGS. 3A and 3B are bottom views of exemplary embodiments of a single-pass type print head and a multiple-pass type print head, respectively, constructed in accordance with aspects of the present invention;

FIG. 4A is a schematic representation of a substrate stock formed in accordance with aspects of the present invention, the substrate stock including an exemplary embodiment of a printed image and a printed test pattern;

FIG. 4B is a schematic representation of a substrate stock formed in accordance with aspects of the present invention, the substrate stock including another exemplary embodiment of the printed image and a printed test pattern;

FIG. 5A is an exemplary embodiment of a reference test pattern formed in accordance with aspects of the present invention;

FIG. 5B is one embodiment of a test pattern printed by a print head of the print station wherein the print head has an operational problem, such as clogged print head nozzles;

FIG. 6 is an exemplary embodiment of a process for verifying the operational conditions of a printing system in a digital printing environment; and

FIG. 7 is an exemplary embodiment of an image analysis routine suitable for use by the process of FIG. 6.

### DETAILED DESCRIPTION

Embodiments of the present invention are directed to systems and methods for verifying the operational conditions of printing systems in a digital printing environment. The following description provides examples of digital printing systems and methods for generating image data on a selected substrate and methods for verifying the operational conditions of the printing system. In several embodiments, the operational conditions to be verified include, but are not limited to, clogged print head nozzles, insufficient ink delivery to the print head, etc.

Embodiments of the present invention provide automated print verification techniques, the result of which decreases the possibilities of wasted print time and product stock (e.g., substrate material and inks). Applications of the embodiments of the systems and methods of the present invention may reduce labor costs, extend operating hours at the print facility, etc. It should be apparent that the examples described below are only illustrative in nature and, therefore, such examples should not be considered as limiting the scope of the present invention, as claimed.

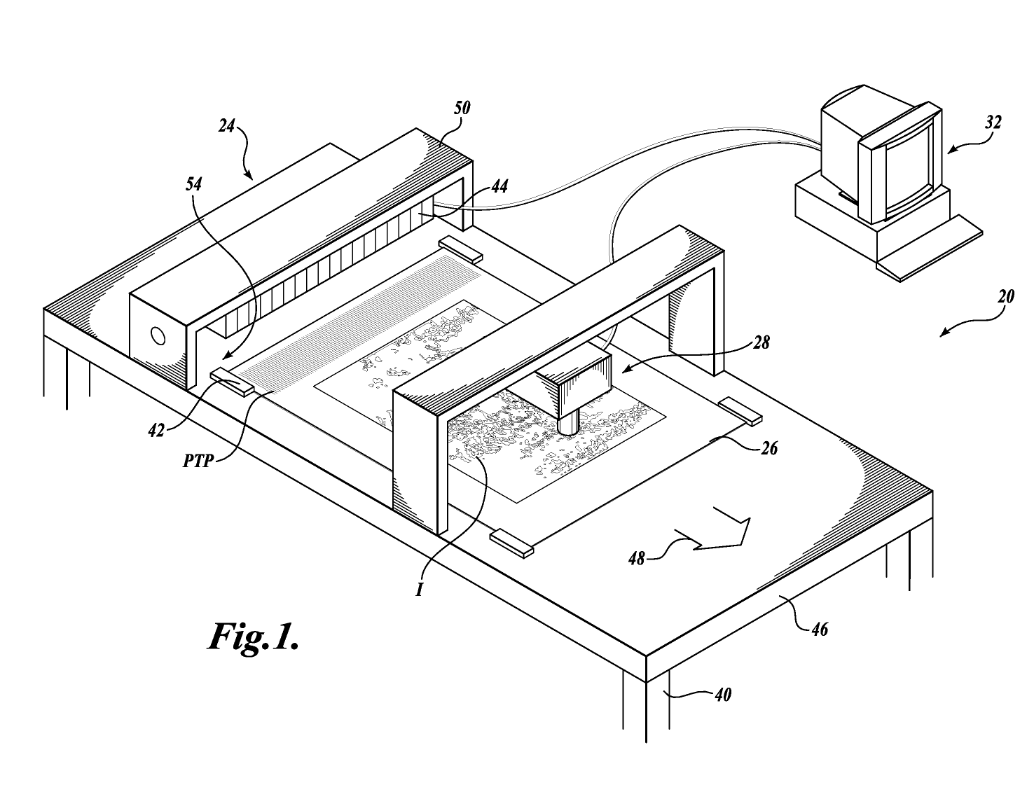

Turning now to FIG. 1, there is shown a perspective view of one exemplary embodiment of a print verification system, generally designated 20, formed in accordance with aspects of the present invention. As best shown in FIG. 1, the print verification system 20 includes a print station 24 for printing an image I and a test pattern TP onto a selected substrate stock 26, an image capture device 28 for capturing a digital image on the test pattern TP, and a computing system 32 for controlling the printing process. As will be described in more detail below, the computing system 32 includes an image analysis module for analyzing the images captured by the image capture device 28. Based on the results of the analysis of the captured image, the system 20 may generate an alert signal indicative of adverse operational conditions of the print station 24. The alert signal may be a signal that 1) notifies an operator, such as a page, an e-mail, an audible alert, a visual alert, etc.; 2) stops the print run; and/or 3) stops the print run and initiates a print head cleaning cycle.

Referring now to FIGS. 1-5B, the components of the print verification system 20 will be described in more detail. The print station 24 may be any conventional inkjet printer, wide format inkjet printer or plotter, or printer assembly that includes an inkjet print head. In the embodiment shown in FIG. 1, the print station 24 comprises a frame 40, a substrate advancement mechanism 42, an inkjet print head 44, and a platen or bed 46 for supporting the substrate stock 26 on which the image I is printed by the inkjet print head 44 as the substrate advancement mechanism 42 advances the substrate stock 26 through the print station 24 in the direction of the arrow 48. The platen or bed 46 is supported in a stationary manner by the frame 40. The print head 44 is suspended a spaced distance above the platen or bed in a stationary manner by an upper frame section or bracket member 50. As such, the print head 44 in this embodiment operates as a single-pass type print station. The space between the print head 44 and the platen or bed 46 forms a printing nip 54.

Alternatively, the print head may be mounted to a carriage that reciprocates transversely to the substrate advancement direction along a guide rail (not shown). The movement of the carriage is effected by a drive motor that is controlled by the computing system via a conventional linear actuator, jack screw, belt drive, etc. In this embodiment, the print head reciprocates back and forth to print swaths of ink and, thus, operates as a multiple-pass type print station.

As was briefly described above, the substrate stock 26 may be advanced through the printing nip 54 and optionally through the print station 24 by the substrate advancement mechanism 42. The substrate advancement mechanism 42 is illustrated schematically in FIG. 1, and can be any mechanism known in the art for controllably advancing a sheet of substrate stock through the print station, such as clamp bars/conveyor means. The substrate advancement mechanism 42 may be driven by one or more electric motors 86 that receive control signals from the computing system 32 for controlling the advancement of substrate stock 26. It will be appreciated that the computing system 32 synchronizes the advancement of the substrate stock 26 and the operation/movement of the print head 44 to arrive at the final printed image I.

In embodiments where the substrate stock is in web form, the substrate advancement mechanism includes conventional motorized rollers (not shown), the operation of which are controlled by the computing system. It will be appreciated that other conventional components may be utilized by the print station including, but not limited to, position sensors 88, substrate alignment structure, etc. The substrate alignment structure may be used to maintain proper alignment of the substrate stock as the substrate stock is advanced through the print station, and the position sensors 88 can be used to determine the position of the substrate stock during the printing process.

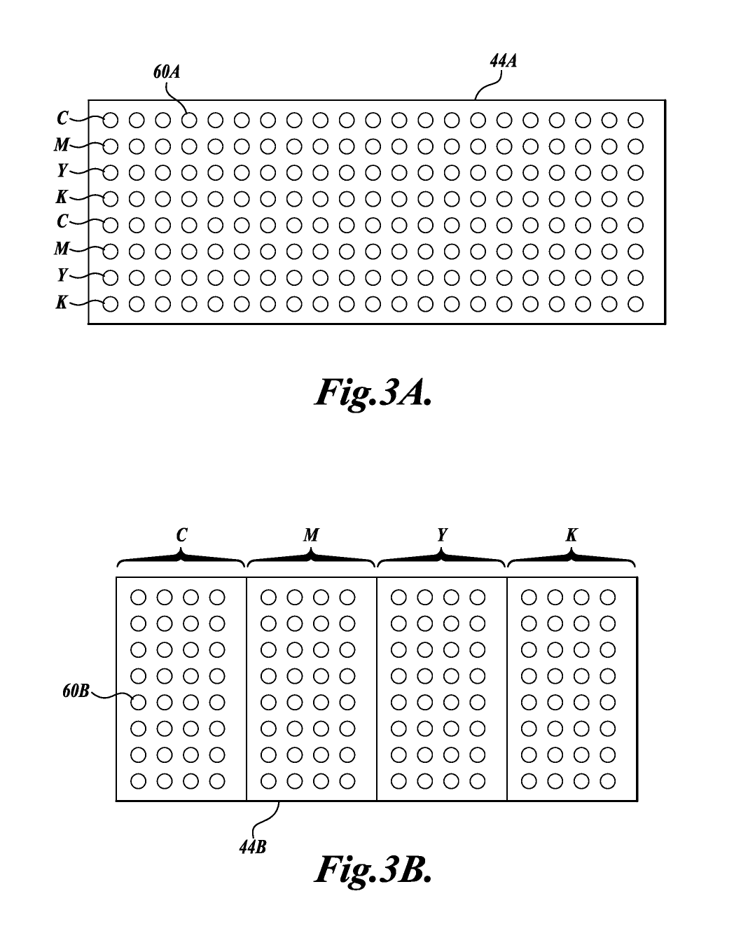

FIG. 3A is a bottom view of one embodiment of an inkjet print head 44A that may be practiced with the present invention. The print head 44A is used in a single pass printing environment and includes an array of selectively activatable print elements 60A, each including a nozzle for ejecting inks onto a substrate in any color, such as Cyan (C), Yellow (Y), Magenta (M), and Black (K), onto a substrate. FIG. 3B is a bottom view of another embodiment of an inkjet print head 44B that may be practiced with the present invention. The print head 44B is used in a multiple-pass printing environment and includes an array of activatable print elements 60B, each including a nozzle for ejecting inks onto the substrate in any color, such as Cyan (C), Yellow (Y), Magenta (M), and Black (K). These print heads may be composed of multiple smaller array elements incorporated together to achieve the number of nozzles and colors required to meet the printing specifications (e.g., speed, quality, resolution, etc.) of the printing device.

In operation, a sheet or web of substrate stock 26 (shown as a sheet in FIG. 1) is passed through the printing nip 54 of the print station 24 via conventional substrate advancement mechanism 42. As the substrate stock 26 is advanced through the printing nip 54, the print head 44 ejects ink onto the substrate stock 26 to form the printed image I. Each print element nozzle of the print head 44 ejects the ink droplet in a predefined print position on the substrate stock 26. An assembly of the adjacently positioned ink droplets creates the predetermined print pattern or image I. The image I is printed at a specific location mandated by print data stored in the computing system 32. For the purposes that will be described in more detail below, the print head 44 further prints a test pattern TP onto a portion of the substrate stock 26 either prior to, contemporaneously with, or after the desired printed image I. The test pattern could be printed once for each printed image or, alternatively, printed once for every multiple number of printed images. The test pattern could also be printed fully, including all components, or in sections by separate component groups. The selection of test pattern printing frequency and/or composition would primarily depend on the manufacturing needs (e.g., system reliability, speed, unprinted substrate area, image capture device field of view and resolution, etc.)

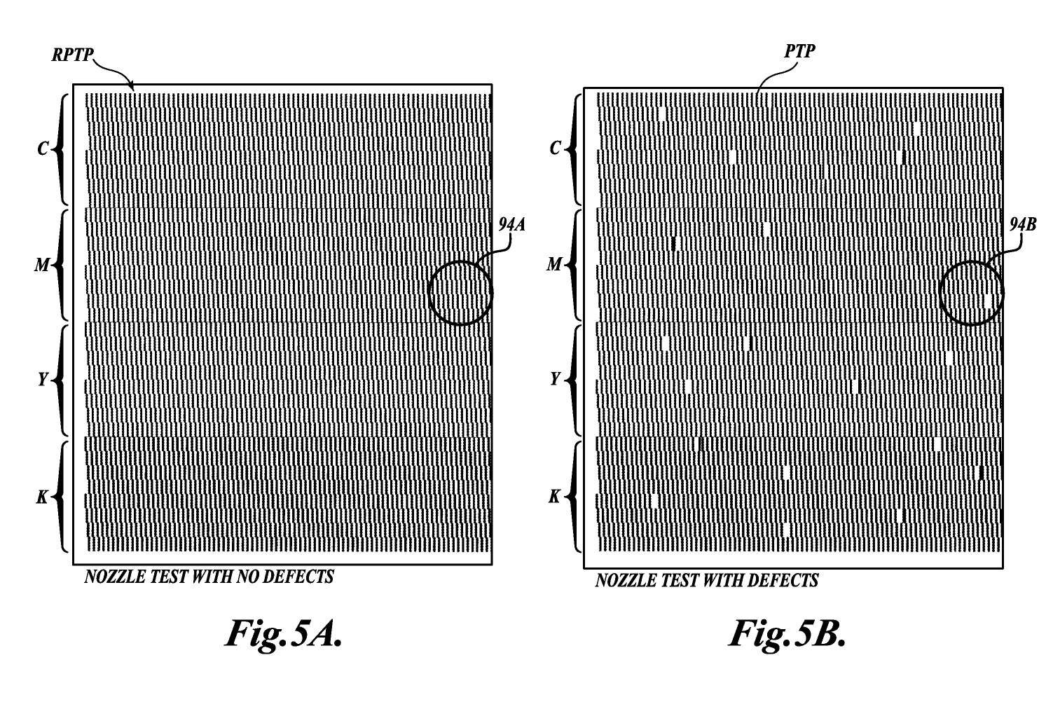

The system 20 further includes an image capture device 28 for capturing print data, for example, the printed test pattern PTP, which was printed onto the substrate stock 26 by the print head 44. The test pattern may be comprised of any configuration of lines, dots, etc., that utilize all, or selected portions, of the print element nozzles of the print head 44. FIG. 5A illustrates one embodiment of a printed test pattern PTP that may be suitable for use in several embodiments of the present invention (the test pattern in FIG. 5A may also be referred to as a reference printed test pattern RPTP). As best shown in FIG. 5A, the test pattern includes an array of spaced apart lines comprised of aligned dots. The lines are printed in each color ink, for example, CMYK colored inks. The lines of the array are arranged in rows. As will be described in more detail below, FIG. 5B illustrates a printed test pattern that is representative of an adverse operational condition.

In the embodiment shown in FIGS. 5A-5B, the test pattern can be generated by staggering the output of each print element nozzle in the print head array. For example, the first row of lines is printed by print element nozzles 1, 5, 9, 13, etc., in a given color, for example, cyan. The next row of lines is printed by print element nozzles 2, 6, 10, 14, etc., in the same color. As such, the lines created by this staggered effect provide space between the lines and allow for easier image processing. The test pattern of FIG. 5A illustrates a repeat of each nozzle or the use of redundant nozzles of each color, as shown with the print head 44A of FIG. 3A.

Returning now to FIG. 1, the image capture device 28 is suspended a spaced distance above the platen or bed 46 in a similar manner as the print head 44. The image capture device is suspended in a suitable position and orientation for capturing a printed test pattern PTP, or portions thereof, from the substrate stock 26 as it passes below or in proximity of the image capture device 28. The image capture device 28 is electrically connected (e.g., wired or wireless) to the computing system 32 for receiving signals from the computing system 32 for capturing the image when the substrate stock is in a suitable position and for sending digital image data of the captured image to the computing system 32 for processing. The image capture device 28 may be any conventional single device or collection of multiple devices that captures images of the print data, such as the printed test pattern PTP, upon receipt of a control signal and generates digital image data to be transferred to the computing system 32 for image analysis. Examples of the image capturing device 28 may include, but are not limited to, CCD sensors, digital cameras, and scanners. It will be appreciated that light sources or other conventional components that may aid in the image capture of print data may be used.

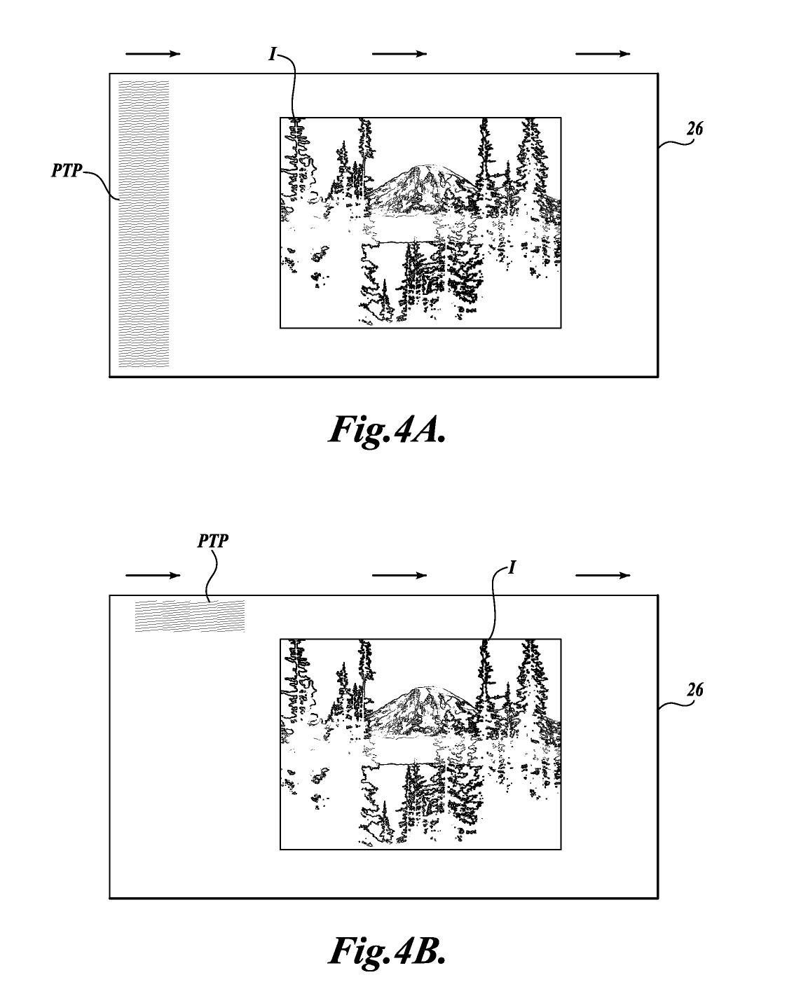

The location and arrangement of the image capture device 28 may vary depending on the type of the print station 24 and image capture device 28 used. For example, in a single pass print station where the print head is stationary and the test pattern is printed across the top or bottom region of the substrate stock 26 (see FIG. 4A), the image capture device 28 will be mounted downstream of the print head 44 in a position that is capable of capturing the entire width of the printed test pattern PTP, as shown in FIG. 1. In embodiments that utilize a multiple-pass print head where the print head is laterally movable and the test pattern TP is printed along one side region of the substrate stock 26 (see FIG. 4B), the image capture device 46 is mounted to the side of the substrate stock, centerline and downstream of the print head 44.

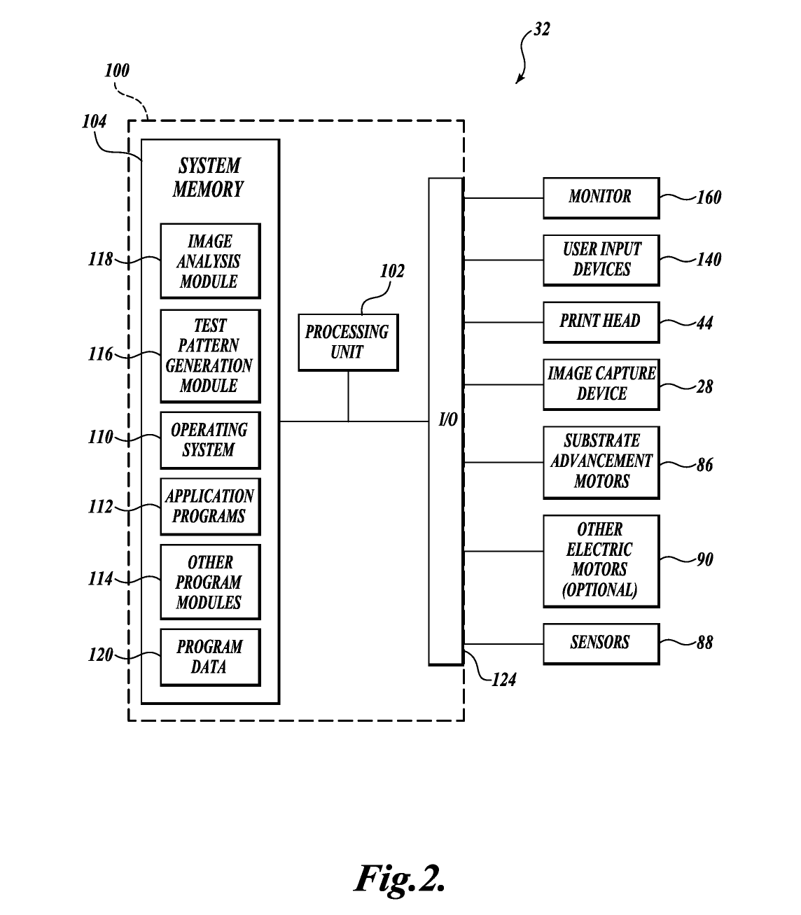

As was describe briefly above, the print station 24 and the image capture device 28 are controlled by the computing system 32. One embodiment of the computing system 32 is illustrated as a block diagram in FIG. 2. Although not required, aspects of the present invention may be described in the general context of computer-executable instructions, such as program modules, being executed by a personal computer or computing device and stored, for example, on computer readable media, as will be described below. Generally, program modules include routines, programs, objects, components, data structures, etc., that perform particular tasks or implement particular abstract data types.

The computing system 32 includes a computing device 100, including a processing unit 102 and system memory 104 suitably interconnected. The system memory 104 may include read only memory (ROM), random access memory (RAM), and storage memory. The storage memory may include hard disk drives for reading from and writing to a hard disk, a magnetic disk drive for reading from or writing to a removable magnetic disk, and an optical disk drive for reading from or writing to a removable optical disk, such as a CD, DVD, or other optical media. The storage memory and their associated computer-readable media provide non-volatile storage of computer readable instructions, data structures, program modules, and other data for the computing system 32. Other types of computer readable media which can store data that is accessible by a computer, such as magnetic cassettes, flash memory cards, digital video disks, Bernoulli cartridges, random access memories (RAMs), read only memories (ROMs), and the like, may also be used in the exemplary computing system.

A number of program modules may be stored on the system memory 104, including an operating system 110, one or more application programs 112, including desktop publishing programs, such as Adobe Photoshop®, Adobe Illustrator®, and/or Adobe PageMaker®, other program modules 114, such as color ink jet print drivers and/or printing preparation programs, a test pattern generation module 116, an image analysis module 118, and program data 120, such as image files including reference test patterns and print files, etc. The print drivers and/or printing preparation programs are capable of generating print command signals that upon reception from the print head cause the print head 44 to print the desired image. The print drivers and/or printing preparation programs may work in conjunction with the processing unit 102 to form a raster image processor (RIP). Alternatively, the computing system 32 may include an image conversion module as part of or separate from the desktop publishing program, which works in conjunction with the processing unit 102 to form the raster image processor (RIP). The term desktop publishing program is used herein to include all programs, such as image processing programs, image creation programs, raster image processing, page creation programs, that are employed, for example, in the desktop publishing, graphic arts, or engineering drawing industries.

The test pattern generation module 116 is capable of generating appropriate control signals to operate the print head 116. The appropriate control signals, when received by the print head 44, causes the print head 44 to print a predetermined test pattern onto the substrate stock 26. The image analysis module 118 is capable of analyzing the printed test pattern PTP captured by the image capture device 28. In operation, the image analysis module 118 obtains the digital image captured by the image capture device 28 and determines the operational condition of the print head 44 (e.g., whether all or substantially all of the print elements are ejecting ink). In one embodiment, the image analysis module 118 determines the operational condition of the print head 44 by comparing the captured image of the printed test pattern PTP to one or more reference test patterns stored in system memory 104. The image analysis module 118 may use any conventional image analysis techniques for comparing the printed test pattern obtained from the substrate stock with a reference printed test pattern RPTP stored in system memory. In several embodiments, the image analysis module 118 may compare region by region while in other embodiments the image analysis module compares the test pattern as a whole. In one embodiment, the printed test pattern may be compared to the reference printed test pattern specific to the printing device so as to recognize any recurring printed test pattern anomalies already determined as characteristic of the printing device. This characteristic reference test pattern comparison allows anomalies resulting from assignable causes to be ignored so as not to trigger a print detection system alert signal.

The computing system 32 is connected in electrical communication with the motor(s) 86 of the substrate advancement mechanism 42 that is associated with the print station 24, the position sensors 88, and other conveyance mechanism motors 90, if utilized, via input/output circuitry 124 or other device level circuitry. The input/output circuitry 124 or other device lever circuitry is capable of receiving, processing, and transmitting appropriate signals between the processing unit and the sensors, motors, etc. The motor(s) 86, the position sensors 88, and other conveyance mechanism motors 90 are capable of at least the following: 1) controlling the advancement of the substrate stock 26 through the print station 24, and to and from the print station 24; 2) synchronizing the print head 44 and substrate advancement; and 3) determining when the printed test pattern TP is in position to be captured by the image capture device 28. The computing system 32 is further connected in electrical communication with the print head 44 of the print station 24 via the I/O circuitry 124. One such print head that may be practiced with the present invention is the Rhopac digital printer, commercially available from Durst Phototechnik Digital Technology GmbH, Lienz, Austria.

The computing system 32 may further include user input devices 140, such as a keyboard, a pointing device, or the like, suitable connected through appropriate interfaces, such as serial ports, parallel ports or a universal serial bus (USB) of the I/O circuitry 124. A monitor 160 or other type of display device may also be included.

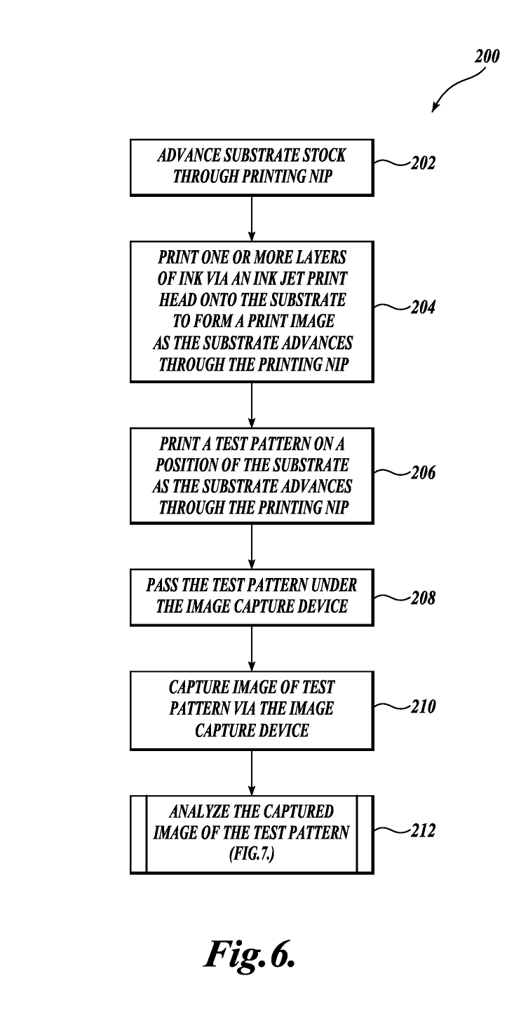

Examples of methods for verifying the operational conditions of a print station, and more particularly, a print head of the print station, will now be described with reference to FIGS. 1-7. Referring first to FIG. 6, there is shown one exemplary process, generally designated 200, for verifying the operational conditions of a printing system in a digital printing environment. The process 200 begins at block 202 by advancing a sheet or web of substrate stock through the printing nip 54 of the print station 24. If using sheets of substrate stock, the substrate stock is first transferred one at a time to the entrance of the print station either manually, or via an automated system comprised of, for example, conventional conveyance means. Once the substrate stock 26 is positioned at the entrance of the print station 24, the sheet of substrate stock 26 may be advanced through the printing nip 54 by the substrate advancement mechanism 42, as generally known in the art. On the other hand, if the substrate stock is in web form, the web of substrate stock may be advanced through the printing nip via motorized rollers, also well know in the art. In either case, it will be appreciated that the computing system 32 generates and outputs appropriate control signals to the motors/actuators for advancement of the substrate stock 26.

Next, at block 204, one or more layers of ink are printed onto the substrate stock 26 via the ink jet print head 44 for generating a desired printed image I. In embodiment where a multiple-pass printing arrangement is used, it will be appreciated that the layers of ink may be printed sequentially via one or more passes of the print head. In other embodiments where a single pass printing arrangement is used, the layers of ink are sequentially printed as the substrate stock makes a single pass under the print head. The print head 44 applies the ink to the substrate stock 26 according to the print signals sent to the print head 44 via the computing system 32 and, for example, generated by the raster image processor. It will be appreciated that the image I may be printed using any one of a combination of ink colors, including but not limited to cyan (C), yellow (Y), magenta (M), and black (K).

Prior to, contemporaneously with, or after the image I is printed onto the substrate stock 26 by the print head 44, a test pattern is printed onto a portion of the substrate stock 26 as a result of suitable print signals generated by the test pattern generation module 116 and transmitted to the print head 44. As was described in detail above, the printed test pattern PTP can be in the form of lines, dots, etc., and may be located along any portion of the side, top, or bottom of the substrate stock, as shown in FIGS. 4A and 4B. It will be appreciated that the test pattern is printed on portions of the substrate stock that will be subsequently discarded, e.g., cut away, from the final product.

After the test pattern is printed at block 206, the process proceeds to block 208, where the substrate stock 26 is advanced to a position under or in close proximity to the image capture device 28. Depending on what type of image capturing device 28 is used, size of the test pattern TP, and speed of the substrate stock 26 as it is advanced through the print station 24, the substrate stock 26 may be stopped under or in close proximity to the image capture device 28 or continuously advanced through the capture zone of the image capture device 28. Position sensors 88 may be used to signal the computing system 32 to stop the substrate advancement mechanism 42, if desired. Position sensor 88 may also be used to determine when the substrate stock 26 is in an appropriate position to capture the image of the test pattern TP. Upon appropriate signals from such sensors, control signals are transferred from the computing system 32 to the image capture device 28, resulting in the image capture of the printed test pattern PTP at block 210.

Once the printed test pattern PTP is captured by the device 28 at block 210, the process 200 proceeds to block 212 where the captured image is analyzed by an image analysis routine. For example, once the printed test pattern PTP is captured, the digital data representing the captured image are transferred to the computing system 32 where it is analyzed by the image analysis module 118. The image analysis module 118 determines the operational condition of the print head 44 (e.g., whether all or substantially all of the print elements are ejecting ink). The image analysis module 118 may use any conventional image analysis techniques for analyzing the captured printed test pattern. Examples of image analysis techniques that may be used include, but are not limited to, intensity level thresholding, wavelet filtering, etc.

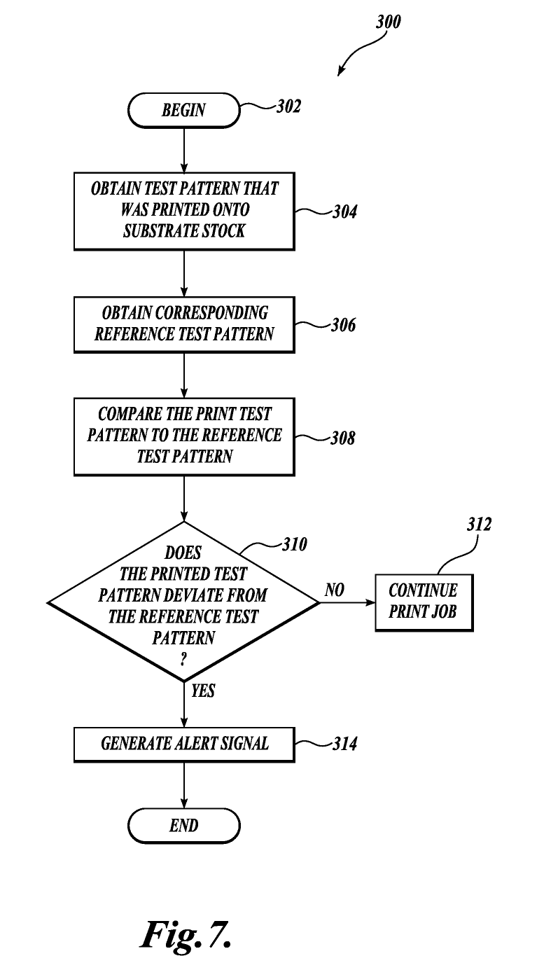

Turning now to FIG. 7, there is shown a block diagram of one exemplary image analysis routine 300 executed by the image analysis module 118 that may be practiced with the present invention. The routine 300 begins at block 302 and proceeds to block 304, where the digital image of the printed test pattern PTP captured by the image capture device 28 is obtained from system memory 104. One such printed test pattern PTP is shown in FIG. 5B. The routine 300 continues to block 306 where a reference test pattern image is obtained from system memory 104. The obtained reference test pattern image corresponds to the printed test pattern PTP and is representative of a printed test pattern that is generated by a print head having all of its print elements working properly, or working in the best possible condition for the printing device. One such reference printed test pattern RPTP is shown in FIG. 5A. It will be appreciated that the image analysis module 116 may obtain information from the test pattern generation module 116 regarding the type of test pattern generated by the module 116 and printed by the print head 44 so that an appropriate reference test pattern is obtained. Alternatively a reference test pattern could be a stored reference test pattern representing a previously captured printed test pattern representing the characteristic printed test pattern results for the printing device.

Next, at block 308, the obtained image of the printed test pattern PTP is compared to the reference test pattern obtained from the memory 104 for determining the operational conditions of the print head 44. In several embodiments, the image analysis module 118 compares region by region while in other embodiments the image analysis module compares the test pattern as a whole. For example, in a region by region analysis, the region designated 94B in FIG. 5B is compared to the corresponding region, designated 94A, in FIG. 5A. The routine 300 then proceeds to block 310, where a determination is made as to whether the printed test pattern TP deviates from the reference test pattern. For example, a determination can be made as to whether, on a region by region basis, the deviation exists between the printed test pattern TP and the reference test pattern. In the example shown in FIGS. 5A and 5B, it would be determined that the region 94B of FIG. 5B deviates from region 94A of FIG. 5A since ink was not printed in the region 94B of FIG. 5B when compared to the region 94A of FIG. 5A.

If it is determined at block 310 that the printed test pattern TP deviates from the reference test pattern, the routine proceeds to block 314, where an alert signal is generated. However, if it is determined that the deviation does not exist, then the print head is deemed to be working properly, and thus, the routine proceeds to block 312 where the print job is continued uninterrupted. The alert signal could be an automatic page, a telephone or cellular phone call, an e-mail, or other means for notifying an operator that is located remote from the print station. It may also include an audible signal, such as a horn or buzzer, a visible signal, such as a flashing red light, etc. Further, the alert signal could shut down the print station until operator input is obtained, or the print run could be stopped and a targeted or global print head cleaning cycle could be initiated. It may also cause the operator to manually check the equipment and the ink supply lines to the print head. If a cleaning cycle is initiated, the computing system could initiate another print head verifying process after the cleaning cycle is complete to determine whether further actions by the operator are required.

It will be appreciated that a margin of error may be factored into the determination. For example, if it is determined that the amount of deviation is below a predetermined threshold percentage, e.g., 5%, then no alert signal is generated, and the print head is deemed suitable to continue uninterrupted through the print job. If, however, it is determined that the deviation is greater than the threshold percentage, an alert signal is generated. Further, it will be appreciated that levels of deviation may be utilized to generate various types of alerts. For example, a deviation of 5% could generate a call or other notification to the operator but the print job still continues, whereas a deviation of 10% could generate an audible or visual alert, a shut down of the print cycle, and an initiation of a cleaning cycle.

If it is determined that based on the operational conditions of the print head that the print cycle should continue uninterrupted, the substrate stock 26 is further advanced so as to exit the print station 24. After the sheet stock exits the print station 24, the substrate stock may be further transferred either manually or by any conventional conveyor systems for further processing. Further processing may include but is not limited to scoring, cutting, folding, gluing, etc., in order to form the final product.

Embodiments of the substrate stock described herein may be formed from cellulose based substrates. Cellulose based substrates are formed from cellulose materials such as wood pulp, straw, cotton, bagasse, and the like. Cellulose based substrates useful in the present invention come in many forms such as fiberboard, containerboard, corrugated containerboard, and paperboard. It will be appreciated that other substrates may be utilized in embodiments of the present invention, including but not limited to plastic, fabric, glass, ceramics, etc.

Although the detailed description has been described herein with reference to exemplary embodiments illustrated in the attached drawings, it is noted that substitutions may be made and equivalents employed herein without departing from the scope of the present invention, as recited in the claims. For example, while the image capture device 28 has been illustrated and described as being associated with the print station 24, the image capture device 28 could be located discrete from the print station, such as a separate image capture station, or as associated with other processing equipment. Further, the test patterns need not be printed on each substrate stock of the production run. Instead, a test pattern may be printed and an image analysis routine run on, for example, every other sheet of substrate stock, one of every ten sheets of substrate stock, or randomly printed on sheets of the substrate stock during the production run.

The embodiments of the invention in which an exclusive property or privilege is claimed are defined as follows:

1. A method for verifying the print quality of a printed image, comprising:
advancing a substrate through a printing nip;
printing one or more layers of ink via an inkjet print head onto the substrate to form a print image;
printing a test pattern on the substrate comprised of one or more ink colors via the print head as the substrate is advanced through the printing nip;
capturing a digital image of the test pattern; and
analyzing the digital image of the test pattern to determine the operational condition of the print head.

2. The method of claim 1, wherein the substrate is selected from a group consisting of fiberboard, containerboard, corrugated containerboard, plastic, glass, fabric, and cellulous fiber.

3. The method of claim 1, wherein the substrate is either in the form of a discrete sheet or a web.

4. The method of claim 1, wherein the print head comprising a plurality of nozzles arranged in an array.

5. The method of claim 1, wherein the print head is stationary as the substrate is advanced through the printing nip.

6. The method of claim 1, wherein the print head moves in a direction perpendicular to the direction of substrate advancement.

7. The method of claim 1, wherein the test pattern is printed prior to or after the printed image.

8. The method of claim 1, wherein the test pattern is printed contemporaneously with the printed image.

9. The method of claim 1, wherein the test pattern is printed along a side portion of the substrate.

10. The method of claim 9, wherein the test pattern is oriented along the direction of substrate advancement.

11. The method of claim 9, wherein the test pattern is oriented orthogonal to the direction of substrate advancement.

12. The method of claim 1, wherein the test pattern is form by an array of lines or dots.

13. The method of claim 1, wherein the digital image is captured by a device selected from a group consisting of a CCD sensor, a digital camera, and a scanner.

14. The method of claim 1, further comprising:
generating an alert signal based on the results of the analysis of the digital image.

15. The method of claim 14, wherein the alert signal is selected from a group consisting of visual signal, audible signal, a page, a telephone call, an e-mail, and a cell phone call, a control signal for stopping the advancement of the substrate, and a control signal for stopping the advancement of the substrate and initiating a print head cleaning cycle.

16. A method for verifying the print quality of a printed image, comprising:
advancing a substrate through a printing nip;
printing one or more layers of ink via an inkjet print head onto the substrate to form a print image;
printing a test pattern on the substrate comprised of one or more ink colors via the print head as the substrate is advanced through the printing nip;
capturing a digital image of the test pattern;
comparing the digital image of the test pattern to a corresponding reference test pattern for determining the operational condition of the print head; and
generating an alert signal based on results of the analysis of the printed test pattern indicating an adverse operational condition of the print head.

17. The method of claim 16, wherein the test pattern is printed prior to or after the printed image.

18. The method of claim 16, wherein the test pattern is printed contemporaneously with the printed image.

19. The method of claim 16, wherein the substrate is selected from a group consisting of fiberboard, containerboard, corrugated containerboard, plastic, glass, fabric, and cellulous fiber.

20. The method of claim 16, wherein the digital image is captured by a device selected from a group consisting of a CCD sensor, a digital camera, and a scanner.
